(19) United States
(12) Patent Application Publication
(10) Pub. No.: US 2009/0155125 A1
(43) Pub. Date: Jun. 18, 2009

(54) MICROCHIP

(75) Inventors: Yoko Michiue, Kyoto-shi (JP); Youichi Aoki, Kyoto-shi (JP)

Correspondence Address: FISH & RICHARDSON P.C., P.O. BOX 1022, MINNEAPOLIS, MN, 55440-1022, US

(73) Assignee: Rohm Co., Ltd., Kyoto (JP)

(21) Appl. No.: 12/269,915

(22) Filed: Nov. 13, 2008

(30) Foreign Application Priority Data
Nov. 14, 2007 (JP) 2007-295388
May 27, 2008 (JP) 2008-138314

(51) Int. Cl. G01N 1/28; B01L 3/00

(52) U.S. Cl. 422/100; 422/99

(57) ABSTRACT

A microchip is provided which includes a fluid circuit in which a first substrate having a groove provided on the surface of the substrate and a second substrate are bonded together. The fluid circuit includes at least a measuring portion for measuring the liquid and a flow path connected to one end of the measuring portion. The cross section of the measuring portion at the connecting position of the flow path and the measuring portion is shorter in length in the thickness direction of the microchip than the cross section of the flow path at the connecting position of the flow path and the measuring portion.

### BACKGROUND OF THE INVENTION

1. Field of the Invention

The present invention relates to a microchip useful as a μ-TAS (Micro Total Analysis System) or the like that is suitably used for biochemical testing of DNA, protein, cells, immunity, blood, or the like, chemical synthesis, environmental analysis, or the like, and more particularly to a microchip provided with a measuring portion for measuring liquid such as a specimen or a liquid reagent.

2. Description of the Background Art

In recent years, in the field of medicine, health, food, drug creation, or the like, there is an increasing importance of sensing, detecting, or quantitating a biological substance such as DNA (Deoxyribo Nucleic Acid), an enzyme, an antigen, an antibody, protein, virus, or cells as well as a chemical substance. Therefore, various biochips and microchemical chips (hereafter, these will be generally referred to as microchips) are proposed that can conveniently measure such substances. A microchip can perform a series of experiments and analysis operations that are carried out in an experiment laboratory within a chip of several cm to 10 cm square and having a thickness of several mm to several cm, thereby producing a lot of advantages such as reduction of the needed amount of the specimens and reagents to be minute, reduction of the costs, increase in the reaction speed, enablement of testing with a high throughput, and enablement of obtaining a test result directly at the site of collecting the specimen.

Typically, a microchip has a fluid circuit therein, and the fluid circuit is mainly constructed, for example, with portions such as a liquid reagent holding portion that holds a liquid reagent for mixing or reacting with a specimen (as one example of which, blood can be mentioned) or a specific component contained in the specimen or for treating the specimen or the specific component, a measuring portion that measures the specimen or the liquid reagent, a mixing portion that mixes the specimen with the liquid reagent, and a detecting portion that performs analysis and/or testing on the mixture liquid, as well as a fine minute flow path (for example, a flow path having a width of about several hundred μm) that suitably connects these portions. Typically, the microchip is used by being mounted on an apparatus (a centrifugal apparatus) that can apply a centrifugal force to this microchip. By application of a centrifugal force to the microchip in a suitable direction, measurement and mixing of the specimen and the liquid reagent, introduction of the mixture liquid to the detecting portion, and the like can be carried out (see, for example, Japanese Patent Laying-Open No. 2007-017342).

In the case of mixing a specimen or a specific component in the specimen, which is an object of testing/analysis, with a liquid reagent in a microchip and treating the specimen or the specific component with the liquid reagent (or allowing the specimen or the specific component to react with the liquid reagent), the microchip is preferably provided with a measuring portion for measuring the specimen or the specific component and/or a measuring portion for measuring the liquid reagent in order to mix these at a suitable quantity ratio. For example, Japanese Patent Laying-Open No. 64-025058 (see FIG. 3 in particular) discloses a blancet provided with a plasma measuring chamber for measuring the plasma that has been separated by centrifugation from blood and a buffer solution measuring chamber for measuring a buffer solution that is mixed with the plasma.

### SUMMARY OF THE INVENTION

Typically, as disclosed in the above Japanese Patent Laying-Open No. 2007-017342, a liquid reservoir portion (exhaust liquid reservoir) is connected via a flow path to an outlet of a measuring portion for measuring a specimen or the like so as to store liquid such as the specimen that has overflowed at the time of measurement. However, with a structure of the measuring portion that a conventional microchip such as that disclosed in Japanese Patent Laying-Open No. 2007-017342 has, there are cases in which the state of liquid separation of the liquid is poor between the measuring portion outlet and the flow path connected thereto at the time of measurement and, by this, a precise measurement of the liquid is sometimes impossible. Also, after the measurement, the liquid may sometimes flow out from the measurement portion outlet by a surface tension, whereby the liquid quantity of the measured liquid may sometimes fluctuate.

The present invention has been made in order to solve the aforementioned problems, and an objective thereof is to provide a microchip that can measure liquid accurately and can prevent unintended flow of the measured liquid.

In the meantime, as a structure of a measuring portion for measuring a specimen (or a specific component in the specimen) or a liquid reagent that is made to act on this, the one shown in FIG. 11 can be mentioned as an example. A measuring portion 10 shown in FIG. 11 includes a measuring portion main body 20 which is a site (chamber) for measuring liquid such as a specimen or a liquid reagent, a discharging flow path 40 connected to an opening 30 disposed on an upper part of measuring portion main body 20, and an exhaust liquid reservoir 50 connected to the other end of discharging flow path 40. Exhaust liquid reservoir 50 is disposed on the downstream side relative to opening 30 in a centrifugal force direction at the time of introducing the liquid to measuring portion main body 20 so as to be capable of storing the extraneous liquid (exhaust liquid) that has exceeded the capacity of measuring portion main body 20 and hence has overflowed out at the time of introducing the liquid to measuring portion main body 20. The liquid that has flown in from the illustrated arrow direction by application of a centrifugal force to the microchip is introduced into measuring portion main body 20 from opening 30, and extraneous liquid that exceeds the capacity of measuring portion main body 20 passes through opening 30 again to flow through discharging flow path 40 as exhaust liquid to be stored into exhaust liquid reservoir 50. At this time, the liquid surface position of the measured liquid within measuring portion main body 20 will be the illustrated position.

However, measuring portion 10 shown in FIG. 11 has the following problems and leaves room for improvement.

(1) Opening 30 functions both as an introducing inlet for introducing liquid and as a discharging outlet for discharging extraneous liquid, so that the width of opening 30 must be a comparatively large one in order to perform such introduction and discharge of the liquid well. However, in this case, the surface area of the liquid surface of the measured liquid will be large, and the measurement error tends to be large. That is, when the surface area of the liquid surface of the measured liquid is large, the difference of the liquid quantity based on the difference of the liquid surface shape will appear in a conspicuous manner, so that the measurement error tends to be large.

(2) By application of a centrifugal force, the liquid is introduced into measuring portion main body 20, and a part thereof is discharged from opening 30 in the direction of discharging flow path 40. However, there are cases in which the liquid separation between the liquid within measuring portion main body 20 and the liquid that flows out in the direction of discharging flow path 40 immediately after stopping the application of a centrifugal force. As a result of this, the measured liquid may sometimes be drawn in the direction of discharging flow path 40, thereby causing measurement errors.

(3) Since discharging flow path 40 is provided, the occupied area of the measuring portion within the fluid circuit will be comparatively large, and this can be an obstacle against scale reduction of the microchip or designing of the fluid circuit structure.

As a measuring portion capable of solving the aforementioned problems, a measuring portion having a structure such as that shown in FIG. 12 can be considered. A measuring portion 60 shown in FIG. 12 includes a measuring portion main body 70 which is a site for measuring liquid and is provided with an introducing inlet 71 for introducing the liquid and a discharging outlet 72 for discharging the liquid, a discharging flow path 80 connected to discharging outlet 72, and an exhaust liquid reservoir 90 connected to the other end of discharging flow path 80. In a manner similar to the above-described exhaust liquid reservoir 50, exhaust liquid reservoir 90 is disposed on the downstream side relative to discharging outlet 72 in a centrifugal force direction at the time of introducing the liquid to measuring portion main body 70 so as to be capable of storing the exhaust liquid that has overflowed out at the time of introducing the liquid to measuring portion main body 70. The liquid that has flown in from the illustrated arrow direction by application of a centrifugal force to the microchip is introduced into measuring portion main body 70 from introducing inlet 71, and extraneous liquid that exceeds the capacity of measuring portion main body 70 passes through discharging outlet 72 to flow through discharging flow path 80 to be stored into exhaust liquid reservoir 90. At this time, the liquid surface position of the measured liquid within measuring portion main body 70 will be the illustrated position.

According to the measuring portion having a structure shown in FIG. 12, the opening for introducing the liquid and the opening for discharging the liquid are provided separately, and the width of each opening is made narrow, so that the surface area of the liquid surface of the measured liquid can be reduced. Therefore, the measurement error can be made smaller. However, there is still a problem in view of the liquid separation between the liquid within measuring portion main body 70 and the liquid flowing out in the direction of discharging flow path 80 immediately after stopping the application of a centrifugal force and in view of the occupied area of the measuring portion, so that there is still room for improvement.

Therefore, another objective of the present invention is to provide a microchip having a measuring portion by which the measurement error is small, the liquid separation between the liquid within the measuring portion main body and the liquid discharged from the measuring portion main body is good, and the occupied area within the fluid circuit can be restrained to be small.

The present invention provides a microchip having a fluid circuit therein and formed by bonding a first substrate having a groove provided on a surface of the substrate and a second substrate together, wherein the fluid circuit includes at least a measuring portion for measuring liquid and a flow path connected to one end of the measuring portion, and a length of a cross section of the measuring portion at a connecting position of the flow path and the measuring portion in a thickness direction of the microchip is shorter than a length of a cross section of the flow path at the connecting position of the flow path and the measuring portion in the thickness direction of the microchip.

Here, a bottom surface or a ceiling surface of the measuring portion and a bottom surface or a ceiling surface of the flow path may be formed at an identical position relative to the thickness direction of the microchip. Alternatively, a bottom surface and a ceiling surface of the measuring portion may be formed at different positions respectively from a bottom surface and a ceiling surface of the flow path relative to the thickness direction of the microchip.

The fluid circuit may have one or more specimen measuring portions for measuring a specimen subjected to test/analysis and one or more liquid reagent measuring portions for measuring a liquid reagent. In this case, the aforementioned measuring portion for measuring liquid is preferably any one or more measuring portions selected from the specimen measuring portions and the liquid reagent measuring portions. More preferably, all the measuring portions and the flow paths connected thereto satisfy the above-described construction.

It is preferable that the first substrate is a transparent substrate, and the second substrate is a black substrate.

Also, the present invention provides a microchip including a first substrate having a groove on a surface and/or a through-hole that penetrates in a thickness direction and a second substrate laminated on the first substrate, and having a first fluid circuit made of a hollow portion composed of the groove of the first substrate and a surface of the second substrate on a side of the first substrate, wherein the first fluid circuit has a measuring portion for measuring liquid, the measuring portion includes a measuring portion main body that is a chamber for measuring the liquid and includes an introducing inlet disposed at one end thereof for introducing the liquid and a discharging outlet disposed at the other end thereof for discharging the liquid, an opening that is made of the groove provided on the surface of the first substrate or the through-hole penetrating in the thickness direction, and a connecting flow path that connects the discharging outlet and the opening. Here, the measuring portion main body and the opening are disposed to oppose each other with the connecting flow path interposed therebetween.

It is preferable that a depth L of the measuring portion main body is larger than a depth M of the connecting flow path. It is more preferable that a ratio L/M of the depth L of the measuring portion main body to the depth M of the connecting flow path is within a range of from 2/1 to 9/1. Also, it is more preferable that the bottom surface of the measuring portion main body and the bottom surface of the connecting flow path are connected by a tilted surface.

Also, a side wall surface continuous to the bottom surface of the connecting flow path among the side wall surfaces of the groove or the through-hole constituting the opening is preferably tilted relative to the thickness direction of the first substrate so that an inner angle formed by the side wall surface and the bottom surface of the connecting flow path will be smaller than 90 degrees.

Also, the connecting flow path and the opening are preferably connected so that a connecting surface thereof will have an angle relative to a liquid surface of the liquid subjected to measurement within the connecting flow path.

Further, an introducing flow path for introducing the liquid to the introducing inlet is preferably connected to the introducing inlet of the measuring portion main body. In this case, it is more preferable that a depth N of the introducing flow path is smaller than a depth L of the measuring portion main body. It is more preferable that a bottom surface of the measuring portion main body and the bottom surface of the introducing flow path are connected by a tilted surface.

The measuring portion main body preferably has a approximately triangular shape. In this case, it is more preferable that the measuring portion main body is provided with the introducing inlet at one corner and the discharging outlet at another corner in the approximately triangular shape.

The microchip of the present invention may be a microchip including a first substrate having a groove formed on both surfaces and/or a through-hole penetrating in a thickness direction and a second substrate and a third substrate that interpose and hold the first substrate therebetween, and having a first fluid circuit made of a hollow portion composed of the groove disposed on one surface of the first substrate and a surface of the second substrate on a side of the first substrate and a second fluid circuit made of a hollow portion composed of the groove disposed on the other surface of the first substrate and a surface of the third substrate on a side of the first substrate. In this case, the opening is preferably made of a through-hole that penetrates through the first substrate in a thickness direction and connects the first fluid circuit and the second fluid circuit.

According to the present invention, there is provided a microchip by which the liquid separation of the measured liquid is good, and the unintended flow of the measured liquid can be prevented, whereby the liquid can be measured accurately.

Also, the present invention can provide a microchip with reduced occupied space of the measuring portion. By reduction of the occupied space of the measuring portion, further scale reduction of the microchip and alleviation of the restrictions on the fluid circuit structure design can be made. Also, the present invention can provide a microchip having a measuring portion with reduced measurement error, whereby the measurement of the liquid can be made accurately. Measurement of liquid with high precision leads to improvement in the precision and the reliability of testing, analysis, and the like using a microchip.

The foregoing and other objectives, features, aspects and advantages of the present invention will become more apparent from the following detailed description of the present invention when taken in conjunction with the accompanying drawings.

### BRIEF DESCRIPTION OF THE DRAWINGS

FIG. 1 is a top surface view illustrating one example of a first substrate constituting a microchip according to a first embodiment of the present invention.

FIGS. 2A and 2B are enlarged views illustrating peripheries of a region that forms a specimen measuring portion of the first substrate shown in FIG. 1.

FIG. 3 is a cross sectional view illustrating another example of the peripheries of the region that forms the specimen measuring portion of the first substrate.

FIG. 4 is a cross sectional view illustrating still another example of the peripheries of the region that forms the specimen measuring portion of the first substrate.

FIG. 5 is a top surface view illustrating one example of a structure of a measuring portion provided in the microchip according to a second embodiment of the present invention.

FIG. 6 is a schematic cross sectional view along the VI-VI line shown in FIG. 5.

FIGS. 7A, 7B, and 7C are schematic top surface views illustrating a relationship between a connecting surface of a connecting flow path and an opening and a liquid surface of liquid after the measurement.

FIGS. 8A and 8B are plan views illustrating one example of the microchip according to the second embodiment of the present invention, illustrating a state before fluid processing is carried out (before use).

FIGS. 9A, 9B, 10A, and 10B are plan views illustrating a state of the liquid in one step of the fluid processing that is carried out with use of the microchip shown in FIGS. 8A and 8B.

FIG. 11 is a top surface view illustrating one example of the structure of the measuring portion provided in the microchip.

FIG. 12 is a top surface view illustrating another example of the structure of the measuring portion provided in the microchip.

### DESCRIPTION OF THE PREFERRED EMBODIMENTS

### First Embodiment

The microchip according to the present embodiment relates to a microchip having a fluid circuit therein that is formed by bonding a second substrate on a groove-forming-side surface of a first substrate having a groove formed on a substrate surface. The fluid circuit is composed of the groove formed on the surface of the first substrate and the bonding surface of the second substrate. That is, the fluid circuit is made of a hollow portion composed of the groove formed on the first substrate surface and the surface of the second substrate on the side opposite to the first substrate. The size of the microchip is not particularly limited; however, the size can have, for example, longitudinal and lateral sides of about several cm and a thickness of about several mm to 1 cm.

The shape and the pattern of the groove formed on the first substrate surface is not particularly limited, and is determined so that the structure of the hollow portion composed of the groove and the second substrate surface will have a desired suitable fluid circuit structure.

The method for forming a groove (flow path pattern) constituting the fluid circuit on the first substrate surface is not particularly limited, and the injection molding method using a mold having a transfer structure, the imprint method, and the like can be mentioned as examples. In the case of forming a substrate using an inorganic material, the etching method or the like can be used.

The fluid circuit has at least a measuring portion for measuring liquid such as a specimen or a liquid reagent. The fluid circuit may include one measuring portion alone or two or more measuring portions. The measuring portion has a predetermined capacity and, by introducing the liquid into the measuring portion, the liquid of a predetermined amount can be measured. The liquid that has overflowed from the measuring portion is stored into an exhaust liquid reservoir connected to one end of the measuring portion via a flow path. Here, the liquid reagent is a reagent that treats the specimen serving as an object of testing/analysis using the microchip or that is mixed or allowed to react with the specimen. Typically, the liquid reagent is incorporated in a liquid reagent holding portion of the fluid circuit in advance before use of the microchip.

The fluid circuit may have other portions in addition to the measuring portion. The other portions included in the fluid circuit are not particularly limited; however, a liquid reagent holding portion for holding a liquid reagent, a mixing portion for mixing the measured liquid reagent and the measured specimen, a detecting portion for performing testing/analysis on the mixture liquid (for example, detection of a specific component in the mixture liquid), and the like can be mentioned as examples. The microchip of the present embodiment may have all of these exemplified portions or may dispense with any one or more of these porions. Also, the microchip of the present embodiment may have portions other than these exemplified portions. The means for testing/analysis is not particularly limited; however, the testing/analysis can be performed, for example, by optical measurement such as sensing the intensity (transmittance) of the light that is transmitted when light is radiated onto the detecting portion that stores the mixture liquid, or measuring the absorption spectrum on the mixture liquid that is held in the detecting portion.

Here, the “liquid reagent” is a liquid substance that is mixed with the specimen serving as an object of testing/analysis, and is a liquid substance for treating the specimen or being allowed to react with the specimen for performing the testing/analysis using the microchip. Only one kind of the liquid reagent may be incorporated within the microchip, or two or more kinds of the liquid reagents may be incorporated therein. Also, the “specimen” refers to a substance itself that is introduced into the fluid circuit as an object of testing/analysis (for example, blood), or a specific component in the substance (for example, plasma component, blood cell component, or the like). Therefore, the specific component within the specimen may be hereafter simply referred to also as a specimen.

The portions within the fluid circuit are arranged at suitable positions and are connected with each other via a minute flow path so as to be capable of sequentially performing the measurement of a specimen and a liquid reagent, mixing of the specimen with the liquid reagent, introduction of the obtained mixture liquid into the detecting portion, and the testing/analysis of the mixture liquid by application of a centrifugal force from outside. The application of a centrifugal force to a microchip can be carried out typically by mounting the microchip on an apparatus (centrifugal apparatus) capable of applying a centrifugal force thereto. The centrifugal apparatus includes, for example, a rotor (rotator) being freely rotatable with the centrifugal axis located at the center and a stage located on the rotor and being freely rotatable. A centrifugal force can be applied to the microchip in an arbitrary direction by mounting the microchip on the stage, rotating the stage to set the angle of the microchip relative to the rotor in an arbitrary manner, and rotating the rotor with the centrifugal axis located at the center. Hereafter, the present invention will be described in detail by showing one preferable example of the microchip of the present embodiment.

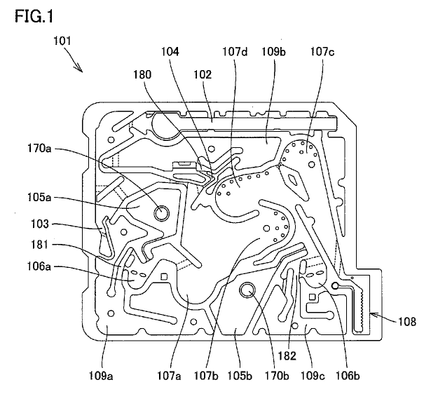

FIG. 1 is a top surface view of a first substrate 101 constituting a microchip 100 which is one example of the microchip of the present embodiment. The “top surface” as used herein refers to the surface on the side on which the groove that forms the fluid circuit is carved. Also, the “bottom surface” refers to the surface on the side on which the groove that forms the fluid circuit is not carved. Microchip 100 is formed by bonding a second substrate (not shown) on the groove-forming-side surface (top surface) of first substrate 101 having a groove formed on the substrate surface and a through-hole penetrating in the thickness direction of the substrate, such as shown in FIG. 1. A fluid circuit is formed by the groove formed on the first substrate 101 surface (top surface) and the bonding surface of the second substrate. Microchip 100 has a fluid circuit structure being suitably applicable as a microchip for collecting a plasma component from whole blood and performing testing/analysis on the plasma component.

Referring to FIG. 1, the fluid circuit that microchip 100 has is mainly constructed with a sample tube mounting portion 102 for incorporating a sample tube such as a capillary containing the whole blood collected from a person to be tested, a plasma separating portion 103 for obtaining a plasma component by removing blood cell components and the like from the whole blood guided out from the sample tube, a specimen measuring portion 104 for measuring the separated plasma component, two liquid reagent holding portions 105a and 105b for holding liquid reagents, liquid reagent measuring portions 106a and 106b for measuring the liquid reagents, mixing portions 107a, 107b, 107c, and 107d for mixing the plasma component with the liquid reagents, and a detecting portion 108 for carrying out the testing/analysis on the obtained mixture liquid.

Microchip 100 is a “liquid reagent incorporating type microchip” in which the liquid reagents are incorporated in advance within the fluid circuit, and the liquid reagents are injected from the side of the bottom surface of first substrate 101 (first substrate 101 side surface in microchip 100) via liquid reagent injecting inlets 170a and 170b which are the through-holes penetrating in the thickness direction of first substrate 101 that are formed in liquid reagent holding portions 105a and 105b. The openings of these liquid reagent injecting inlets are sealed by bonding a sealing label, a seal, or the like on the bottom surface of first substrate 101 (first substrate 101 side surface in microchip 100).

First, one example of the operation method of microchip 100 will be described. Here, the operation method described below is merely one exemplification, so that the present invention is not limited to this method only. First, a sample tube containing the whole blood collected from a person to be tested is mounted on sample tube mounting portion 102. Next, a centrifugal force is applied to microchip 100 in the left direction in FIG. 1 (hereafter referred to simply as the left direction, the same applying to the other directions as well), so as to take out the whole blood in the sample tube. Thereafter, by application of a centrifugal force in the downward direction, centrifugal separation is carried out by introducing the whole blood into plasma separating portion 103, so as to separate the whole blood into a plasma component (upper layer) and a blood cell component (lower layer). At this time, the excess whole blood is stored into an exhaust liquid reservoir 109a. Also, by application of this downward centrifugal force, the liquid reagent X within liquid reagent holding portion 105a is introduced into liquid reagent measuring portion 106a to be measured. The liquid reagent X that has overflowed out from liquid reagent measuring portion 106a passes through a flow path 181 connected to the exit-side end of liquid reagent measuring portion 106a to be stored into exhaust liquid reservoir 109a.

Subsequently, by application of a centrifugal force in the rightward direction, the separated plasma component within plasma separating portion 103 is introduced into specimen measuring portion 104 to be measured. The plasma component that has overflowed out from specimen measuring portion 104 passes through a flow path 180 connected to the exit-side end of specimen measuring portion 104 to be stored into an exhaust liquid reservoir 109b. Also, the measured liquid reagent X moves to mixing portion 107b, and the liquid reagent Y within liquid reagent holding portion 105b is discharged from liquid reagent holding portion 105b.

Next, by application of a downward centrifugal force, the measured plasma component and the measured liquid reagent X move to mixing portion 107a to be mixed with each other. Also, the liquid reagent Y is introduced into liquid reagent measuring portion 106b to be measured. The liquid reagent Y that has overflowed out from liquid reagent measuring portion 106b passes through a flow path 182 connected to the exit-side end of liquid reagent measuring portion 106b to be stored into an exhaust liquid reservoir 109c. Subsequently, by sequential application of rightward, downward, and rightward centrifugal forces, the mixture liquid of the plasma component and the liquid reagent X is moved forward and backward between mixing portions 107a and 107b so as to perform sufficient mixing of the mixture liquid.

Subsequently, by application of an upward centrifugal force, the mixture liquid of the plasma component and the liquid reagent X is mixed with the measured liquid reagent Y in mixing portion 107c. Then, by sequential application of leftward, upward, leftward, and upward centrifugal forces, the mixture liquid is moved forward and backward between mixing portions 107c and 107d so as to perform sufficient mixing of the mixture liquid. Finally, by application of a centrifugal force in the right direction, the mixture liquid within mixing portion 107c is introduced into detecting portion 108. The mixture liquid stored in detecting portion 108 is subjected, for example, to optical measurements such as described above, so as to perform testing/analysis.

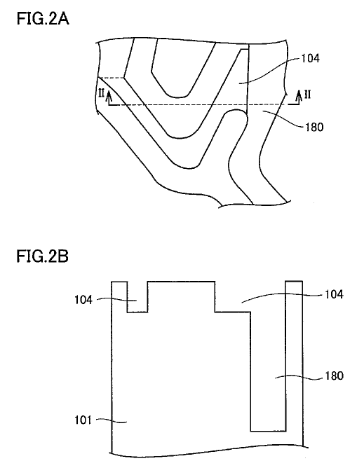

FIGS. 2A and 2B are enlarged views showing peripheries of the region that forms specimen measuring portion 104 of first substrate 101 used in microchip 100. FIG. 2A is a top surface view thereof (surface on the groove-forming side of first substrate 101), and FIG. 2B is a cross sectional view along the line II-II shown in FIG. 2A. As shown in FIG. 2B, at the connecting position of specimen measuring portion 104 and flow path 180, the length (depth) of the specimen measuring portion 104 cross section in the thickness direction of the microchip is shorter than the length (depth) of the flow path 180 cross section in the thickness direction of the microchip at the connecting position. Specifically, the length (depth) of the specimen measuring portion 104 cross section in the thickness direction of the microchip at the connecting position can be, for example, about 0.5 mm, and the length (depth) of the flow path 180 cross section in the thickness direction of the microchip at the connecting position can be, for example, about 2.5 mm.

In this manner, by providing a difference between the depth of specimen measuring portion 104 and the depth of flow path 180 connected thereto so as to make a difference in level in the exit region of specimen measuring portion 104 (connecting position of specimen measuring portion 104 and flow path 180), the liquid separation of the specimen at the connecting position is improved by the surface tension that the specimen has. This allows accurate measurement that accords to the capacity of specimen measuring portion 104. Also, even after the measurement, the specimen is prevented from flowing out to the flow path 180 side by surface tension of the specimen, so that the fluctuation of the quantity of the measured specimen caused by unintended flowing out of the specimen can be prevented. The above-described effect produced by providing a larger depth of flow path 180 to form a difference in level in this manner is conspicuous in a case in which the measured liquid is hydrophilic liquid.

Here, in the above-described example, the depth of the specimen measuring portion (the length of the cross section at the connecting position) is set to be about 0.5 mm, and the depth of the flow path connected thereto (the length of the cross section at the connecting position) is set to be about 2.5 mm. However, the depths are not limited to these values as long as the liquid separation is sufficiently improved by surface tension of the specimen and the flowing out to the flow path side is effectively prevented. Specifically, in order to produce such an effect, the ratio of the depth of the flow path to the depth of the specimen measuring portion is preferably about 1.5 to 10, more preferably about 2.0 to 5.0.

Also, in the example shown in FIG. 2B, the ceiling surface of specimen measuring portion 104 and the ceiling surface of flow path 180 (these two ceiling surfaces are constructed with a second substrate surface not illustrated in FIG. 2B) are formed at an identical position relative to the thickness direction of the microchip. By providing a different distance from the ceiling surface to each of the bottom surfaces, a difference in level is provided at a connecting position between specimen measuring portion 104 and flow path 180.

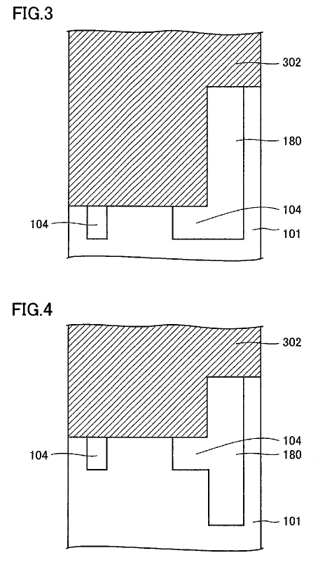

As means for providing a difference in level at a connecting position between the specimen measuring portion and the flow path, in addition to such means, the following methods can be mentioned: (1) a method of forming a bottom surface of specimen measuring portion 104 and a bottom surface of flow path 180 at an identical position relative to the thickness direction of the microchip and providing a different distance from the bottom surface to each of the ceiling surfaces to provide a difference in level as shown in FIG. 3, (2) a method of forming a bottom surface and a ceiling surface of specimen measuring portion 104 at different positions respectively from a bottom surface and a ceiling surface of flow path 180 relative to the thickness direction of the microchip and providing a difference in level by providing a different distance between each bottom surface and each ceiling surface as shown in FIG. 4, and the like. However, in the above-described cases of (1) and (2), a groove must be formed on the surface of a second substrate 302, so that, in consideration of the facility and efficiency in producing the microchip, it is preferable to form a difference in level by a construction such as that shown in FIG. 2B. With such a construction, a difference in level can be provided without forming a groove on the second substrate.

The difference in level structure as shown above can be applied to other portions in addition to specimen measuring portion 104. For example, by providing a similar difference in level at a connecting position between liquid reagent measuring portion 106a and flow path 181 connected to the exit side of the measuring portion, at a connecting position between liquid reagent measuring portion 106b and flow path 182 connected to the exit side of the measuring portion, and the like, the above-described effects can be produced for these portions as well. The ratio of the depth of the liquid reagent measuring portion to the depth of the flow path is preferably from about 1.5 to 10, more preferably from about 2.0 to 5.0.

Here, with reference to FIG. 2A, the flow path width of specimen measuring portion 104 at the connecting position between specimen measuring portion 104 and flow path 180 (the exit terminal of specimen measuring portion 104) is made to be larger than the flow path width of the portions other than the connecting position. Similarly, with reference to FIG. 1, the flow path width of the liquid reagent measuring portion at the connecting position between liquid reagent measuring portion 106a and flow path 181 and at the connecting position between liquid reagent measuring portion 106b and flow path 182 is made to be larger than the flow path width of the portions other than the connecting positions. By providing a larger flow path width at the measuring portion exit, the liquid separation at the connecting positions can be further improved.

The material of the first substrate and the second substrate constituting the microchip of the present invention is not particularly limited; however, in consideration of the processability, a resin is preferably used. Among the resins, polystyrene, a cycloolefin polymer (COP), an acrylic resin, and the like are preferably used and, among these, polystyrene is more preferable because of having good humidity resistance and processability (facility in injection molding). Polystyrene is suitable as a resin constituting the microchip subjected to optical measurements also in view of not emitting fluorescence.

As described above, the first substrate is a substrate having a surface on which the groove constituting the fluid circuit is formed. Such a first substrate includes a site onto which the detection light is radiated at the time of optical measurements, so that the first substrate is preferably a transparent substrate, and at least the region through which the detection light passes in the detecting portion must be constructed with a transparent material such as a transparent resin.

The second substrate may be either a transparent substrate or a non-transparent substrate. The bonding of the first substrate and the second substrate can be carried out, for example, by a welding method such as laser welding, heat welding, supersonic wave welding, bonding with use of an adhesive agent, or the like, and the welding method is preferably used. In the laser welding method, the bonding surfaces are fused by radiating laser beams on at least one bonding surface of the first substrate and the second substrate, so as to perform the bonding. At this time, by using a non-transparent substrate (preferably a black substrate) as the substrate, the optical absorptivity increases whereby the laser welding can be efficiently carried out. Therefore, in the case of using a transparent substrate as the first substrate, it is preferable to use a non-transparent substrate, more preferably a black substrate, as the second substrate.

### Second Embodiment

The microchip according to the present embodiment is a chip that can perform various chemical syntheses, testing, analysis, and others by using a fluid circuit that the chip has. In one preferable embodiment, the microchip of the present embodiment is made of a first substrate and a second substrate laminated and bonded onto the first substrate. More specifically, the microchip is formed by bonding a second substrate onto a first substrate having a groove on the surface and/or a through-hole penetrating in the thickness direction so that the groove-forming-side surface of the first substrate will oppose to the second substrate. Therefore, the microchip made of such two sheets of substrates includes a fluid circuit therein made of a hollow portion composed of the groove formed on the first substrate surface and the surface of the second substrate opposing to the first substrate. The shape and the pattern of the groove formed on the first substrate surface is not particularly limited; however, they are determined so that the structure of the hollow portion composed of the groove and the second substrate surface will be a desired suitable fluid circuit structure.

Also, in another preferable embodiment, the microchip of the present embodiment includes a first substrate having a groove disposed on both surfaces of the substrate and/or a through-hole penetrating in the thickness direction, and a second substrate and a third substrate laminated and bonded onto the first substrate so as to interpose the first substrate therebetween. The microchip made of such three sheets of substrates includes a fluid circuit of two layers, namely, a first fluid circuit made of a hollow portion composed of the surface of the second substrate on the side opposing to the first substrate and the groove formed on the surface of the first substrate opposing to the second substrate, and a second fluid circuit made of a hollow portion composed of the surface of the third substrate on the side opposing to the first substrate and the groove formed on the surface of the first substrate opposing to the third substrate. Here, the term “two layers” means that fluid circuits are provided at two different positions relative to the thickness direction of the microchip. The first fluid circuit and the second fluid circuit can be connected by one or two or more through-holes formed in the first substrate and penetrating in the thickness direction.

The method for bonding the substrates is not particularly limited, and for example, a method (welding method) of melting and welding the bonding surface of at least one substrate among the substrates to be bonded, a method of bonding with use of an adhesive agent, or the like can be mentioned. As the welding method, a method of heating and welding the substrate, a method of welding with heat generated at the time of optical absorption by application of light such as laser beams, a method of welding by using an supersonic wave, and the like can be mentioned as examples.

The size of the microchip of the present embodiment is not particularly limited, so that it can have longitudinal and lateral sides of about several cm and a thickness of about several mm to 1 cm.

The material of each of the above-described substrates constituting the microchip of the present invention is not particularly limited, and an organic material such as polyethylene terephthalate (PET), polybutyrene terephthalate (PBT), polymethyl methacrylate (PMMA), polycarbonate (PC), polystyrene (PS), polypropylene (PP), polyethylene (PE), polyethylene naphthalate (PEN), a polyarylate resin (PAR), an acrylonitrile butadiene styrene resin (ABS), a vinyl chloride resin (PVC), a polymethylpentene resin (PMP), a polybutadiene resin (PBD), a biodegradable polymer (BP), a cycloolefin polymer (COP), or polydimethylsiloxane (PDMS), an inorganic material such as silicone, glass, or quartz, or the like material can be used.

In the case of constructing the microchip with two sheets of the first and second substrates, the first substrate having a groove on the surface can be, for example, a transparent substrate. By this, as a part of the fluid circuit, a detecting portion constructed with the groove of the transparent first substrate and the second substrate surface can be formed, whereby optical measurements such as introducing a mixture liquid of the specimen and the liquid reagent serving as an object of testing/analysis into the detecting portion, radiating light onto the detecting portion, and sensing the intensity of transmitted light (optical transmittance) can be performed on the mixture liquid. The second substrate may be a transparent substrate or, alternatively, the second substrate may be made to be a colored substrate by constructing the substrate with a resin and adding carbon black or the like into the resin to form a black substrate. The second substrate is preferably formed to be a colored substrate, more preferably a black substrate. By forming the second substrate to be a colored substrate, the welding method using light such as laser beams can be used. Also, in the case of bonding the substrates by the laser welding method, the bonding surface of the colored substrate is mainly fused and bonded, so that the deformation of the groove formed on the first substrate which is a transparent substrate can be restrained to the minimum.

In the case of constructing the microchip with three sheets of the first substrate, the second substrate, and the third substrate, the second substrate and the third substrate that interpose the first substrate having a groove formed on the two surfaces and/or a through-hole penetrating in the thickness direction therebetween can be, for example, a transparent substrate. By this, as a part of the fluid circuit, a detecting portion constructed with the through-hole penetrating through the first substrate in the thickness direction thereof and the transparent second and third substrate surfaces can be formed, whereby optical measurements such as introducing a mixture liquid of the specimen and the liquid reagent serving as an object of testing/analysis into the detecting portion, radiating light in a direction perpendicular to the microchip surface onto the detecting portion from the microchip top surface (or bottom surface) side, and sensing the intensity of light transmitted from the opposite side thereof (optical transmittance) can be performed on the mixture liquid. The first substrate located between the second substrate and the third substrate is preferably formed to be a colored substrate, more preferably a black substrate.

The method for forming the groove (flow path pattern) constituting the fluid circuit on the first substrate surface is not particularly limited, and the injection molding method using a mold having a transfer structure, the imprint method, or the like can be mentioned as an example. In the case of forming the substrate with an inorganic material, the etching method or the like can be used.

In the microchip of the present embodiment, the fluid circuit (the first fluid circuit and the second fluid circuit in the case of being provided with the fluid circuit of two layers) includes various portions that are disposed at suitable positions within the fluid circuit so as to be capable of performing various suitable processes on the liquid within the fluid circuit, and these portions are suitably connected via fine and minute flow paths.

In the microchip of the present embodiment, the fluid circuit thereof includes at least a measuring portion for measuring liquid such as a specimen serving as an object of testing/analysis or a liquid reagent that is mixed with the specimen. The fluid circuit may include one measuring portion only, or may include two or more measuring portions. The measuring portion according to the present embodiment will be specifically described later.

The fluid circuit may have portions other than the measuring portion. As such portions, for example, the following portions can be mentioned: a separating portion for taking a specific component out from the specimen introduced into the fluid circuit, a liquid reagent holding portion for storing the liquid reagent, a mixing portion for mixing the specimen with the liquid reagent, and a detecting portion (a cuvette for performing optical measurements) for performing testing/analysis of the mixture liquid obtained by mixing the specimen with the liquid reagent (for example, detection or quantification of a specific component in the mixture liquid). The microchip of the present embodiment may have all of these exemplified portions, or may dispense with any or more of these. Also, the microchip may include portions other than these exemplified portions. These portions are arranged at suitable positions within the fluid circuit so as to be capable of performing desired fluid processing, and are connected via a fine and minute flow path. Also, these portions may be provided respectively in a plurality.

Here, the “liquid reagent” is a liquid substance that is mixed with a specimen serving as an object of testing/analysis, and is a liquid substance for treating the specimen or being allowed to react with the specimen in performing the testing/analysis using the microchip. One kind of liquid reagent may be incorporated or two or more kinds of liquid reagents may be incorporated into one microchip. Also, in the present specification, the “specimen” refers to a substance itself that is introduced into the fluid circuit as an object of testing/analysis (for example, blood), or a specific component in the substance (for example, a plasma component, a blood cell component, or the like). Therefore, in the following description, a specific component within the specimen may be simply referred to as a specimen.

Typically, in the case in which the microchip is made of two sheets of substrates (first substrate and second substrate), the microchip of the present embodiment is provided with a liquid reagent injecting inlet for injecting a liquid reagent into the liquid reagent holding portion, which is a through-hole penetrating into the liquid reagent holding portion located in the inside (penetrating through the first substrate in the thickness direction thereof), on the first substrate surface thereof (this surface typically will be an upper side surface at the time of use of the microchip). The microchip of the present invention such as this is subjected to use typically after injection of a liquid reagent through the liquid reagent injecting inlet and bonding a label or a seal for sealing the liquid reagent injecting inlet onto the microchip surface (first substrate surface). Here, in the case in which the microchip is made of three sheets of substrates (first substrate, second substrate, and third substrate), the liquid reagent injecting inlet can be provided as a through-hole that penetrates through the second substrate or the third substrate in the thickness direction thereof.

The mixture liquid that is finally obtained by mixing the specimen with one kind or two or more kinds of liquid reagents is not particularly limited; however, the mixture liquid is subjected, for example, to optical measurements or the like such as a method of radiating light onto a site (for example, a detecting portion) that stores the mixture liquid and sensing the intensity of the transmitted light (optical transmittance), thereby to perform the testing/analysis.

Various fluid processings within the fluid circuit, such as extraction of a specific component from the specimen (separation of unnecessary components), measuring of the specimen and/or the liquid reagent, mixing of the specimen with the liquid reagent, and introduction of the obtained mixture liquid into the detecting portion, can be carried out by sequentially applying a centrifugal force of a suitable direction to the microchip. The application of a centrifugal force to the microchip can be carried out by mounting the microchip on an apparatus (centrifugal apparatus) capable of applying a centrifugal force thereto. The centrifugal apparatus includes, for example, a rotor (rotator) being freely rotatable with the centrifugal axis located at the center and a stage located on the rotor and being freely rotatable. A centrifugal force can be applied to the microchip in an arbitrary direction by mounting the microchip on the stage, rotating the stage to set the angle of the microchip relative to the rotor in an arbitrary manner, and rotating the rotor with the centrifugal axis located at the center.

Hereafter, the measuring portion that the microchip of the present embodiment includes will be described in detail. Here, the description will be made hereafter by using as an example a microchip mainly made of a first substrate and second and third substrates that interpose and hold the first substrate therebetween; however, the microchip of the present embodiment is not limited to this, so that the microchip may be made of two sheets of substrates.

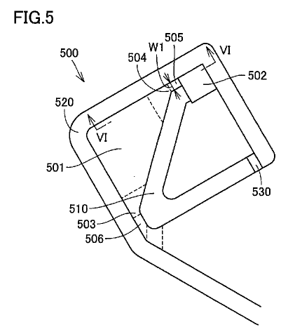

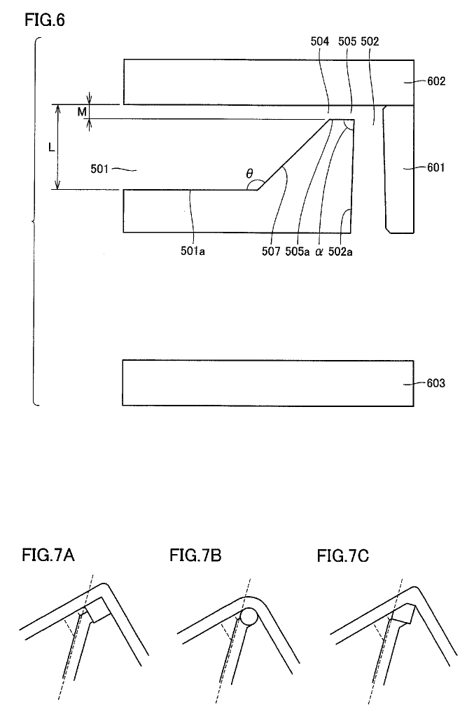

FIG. 5 is a top surface view showing an example of a structure of a measuring portion that the microchip of the present embodiment includes. More specifically, FIG. 5 is a top surface view showing one example of a groove shape of a first substrate 601 that forms the measuring portion that the microchip of the present embodiment has, where a second substrate 602 and a third substrate 603 laminated on first substrate 601 are not shown in FIG. 5. Also, FIG. 6 is a schematic cross sectional view along the VI-VI line shown in FIG. 5 (in FIG. 6, second substrate 602 and third substrate 603 are shown). A measuring portion 500 shown in FIGS. 5 and 6 includes a measuring portion main body 501 which is a chamber for performing measurement of the liquid and having an approximately equal capacity to the amount of the liquid to be measured, and an opening 502 made of a through-hole that penetrates through first substrate 601 in a thickness direction. One end of measuring portion main body 501 has an introducing inlet 503 for introducing the liquid to be measured, and the other end thereof has a discharging outlet 504 for discharging the extraneous liquid (exhaust liquid) that exceeds the capacity of measuring portion main body 501. Discharging outlet 504 and opening 502 are connected by a connecting flow path 505 which is a flow path having a straight line shape. Also, an introducing flow path 506 for guiding the liquid to be measured to introducing inlet 503 is connected to introducing inlet 503.

In measuring portion 500 shown in FIGS. 5 and 6, measuring portion main body 501, connecting flow path 505, and introducing flow path 506 are formed as a region interposed between a first wall 510 and a second wall 520 having a V-letter shape portion. The bottom surfaces of measuring portion main body 501, connecting flow path 505, and introducing flow path 506 are a part of the bottom surface of the groove formed on the first substrate 601 surface.

In measuring portion 500 according to the present embodiment, as shown in FIGS. 5 and 6, measuring portion main body 501 and opening 502 made of a through-hole that penetrates through the first substrate 601 surface in the thickness direction are disposed to oppose each other so as to interpose connecting flow path 505 therebetween. Opening 502 has a function of allowing extraneous liquid (exhaust liquid) that has overflowed from measuring portion main body 501 when the liquid is introduced into measuring portion main body 501, to flow out to “another portion” within the fluid circuit. In the microchip shown in FIGS. 5 and 6, “another portion” refers to an exhaust liquid reservoir or the like that has been formed within a second fluid circuit made of first substrate 601 and third substrate 603.

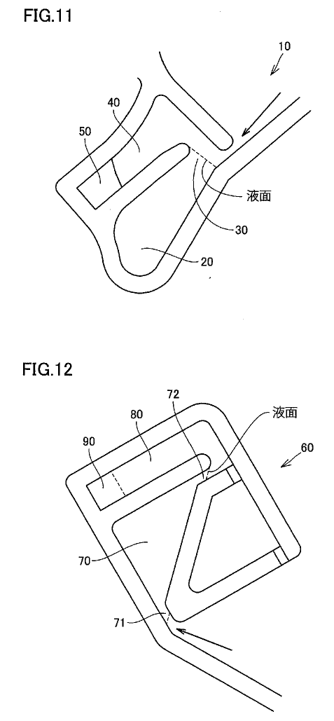

For example, in the measuring portion shown FIGS. 11 and 12 described above, in order to store the exhaust liquid into the exhaust liquid reservoir, the exhaust liquid reservoir must be disposed on the downstream side in the centrifugal force direction relative to the discharging outlet at the time of introducing the liquid to the measuring portion main body. For this reason, the discharging flow path that connects the discharging outlet to the exhaust liquid reservoir must be warped from the discharging outlet so as to be formed to extend to the exhaust liquid reservoir disposed on the downstream side in the centrifugal force direction. In the case of adopting such a structure, there will be posed a problem of increased occupied space of the measuring portion due to the long and warped discharging flow path. Such increase in the occupied space is not desirable for further scale reduction of the microchip, and can also restrict the degree of freedom in the fluid circuit structure design.

In contrast, when the measuring portion main body and the opening for discharging the exhaust liquid are disposed to oppose each other via the connecting flow path as in the measuring portion according to the present embodiment, there will be no restriction on the place of disposing the exhaust liquid reservoir, and there will be no need to warp or elongate the connecting flow path. As a result of this, the occupied space of the measuring portion can be reduced. Also, the liquid (exhaust liquid) that has been discharged from the measuring portion main body passes through the connecting flow path and then falls down from the opening in the thickness direction of the first substrate, so that the liquid separation of the liquid in the measuring portion main body and the liquid within the connecting flow path (the measured liquid) from the liquid (exhaust liquid) flowing out to the opening immediately after stopping the centrifugal force application for introducing the liquid into the measuring portion main body will be good, whereby the measurement errors are hardly generated, and an accurate measurement of the liquid can be performed.

Here, with reference to FIG. 6, the depth L of measuring portion main body 501 is preferably larger than the depth M of connecting flow path 505. When the liquid is measured by introducing the liquid into measuring portion main body 501 through application of a centrifugal force to the microchip and discharging the extraneous liquid exceeding the capacity of measuring portion main body 501 from opening 502 and the application of the centrifugal force is stopped, the liquid surface of the measured liquid will be located within connecting flow path 505. At this time, when the depth M of connecting flow path 505 is made smaller than the depth L of measuring portion main body 501, the surface area of the liquid surface within the connecting flow path 505 will be small, so that the difference of the liquid amount based on the difference of the liquid surface shape is hardly generated, and the measurement errors can be made smaller.

The ratio L/M of the depth L of measuring portion main body 501 to the depth M of connecting flow path 505 is preferably within a range of 2/1 to 9/1. When the ratio is smaller than 2/1, the volume of measuring portion main body 501 will be relatively smaller than the volume of connecting flow path 505 and, as a result of this, the influence given by the difference of the liquid amount of the liquid within connecting flow path 505 to the total amount of the measured liquid based on the difference of the shape of the liquid surface of the liquid after the measurement in connecting flow path 505 will be relatively large, and the measurement errors tend to be large. Also, when the ratio exceeds 9/1, the need for increasing the thickness of first substrate 601 may possibly be generated. Therefore, the ratio is preferably not larger than 9/1 under the circumstances in recent years that demand the scale reduction and thickness reduction of the microchip. Specifically, the depth M of connecting flow path 505 is, for example, about 0.2 to 0.5 mm. When the depth M is smaller than 0.2 mm, the liquid within connecting flow path 505 may in some cases flow out to opening 502 by a capillary phenomenon after the measurement, thereby possibly generating measurement errors. Also, when the depth M exceeds 0.5 mm, the surface area of the liquid surface within connecting flow path 505 will be large, thereby also possibly generating measurement errors. Further, due to reasons similar to those described above, the width WI of connecting flow path 505 (see FIG. 5) is preferably about 0.2 to 0.5 mm.

Here, measuring portion main body 501 preferably has a volume 50 to 150 times as large as the volume of connecting flow path 505. This can reduce the influence given by the difference of the liquid amount of the liquid within connecting flow path 505 to the total amount of the measured liquid based on the difference of the shape of the liquid surface of the liquid after the measurement in connecting flow path 505 can be made small, whereby the measurement errors can be made smaller.

In the case of making the depth M of connecting flow path 505 smaller than the depth L of measuring portion main body 501 as described above, a bottom surface 501a of the measuring portion main body and a bottom surface 505a of the connecting flow path are preferably connected by a tilted surface 507 (see FIG. 6). When a tilted surface is formed in this manner, air can be prevented from staying at the corner portion formed by tilted surface 507 and bottom surface 501a of the measuring portion main body when the extraneous liquid (exhaust liquid) is discharged in the opening 502 direction, whereby measurement errors can be restrained, and the liquid can be measured accurately. With reference to FIG. 6, the angle θ formed by tilted surface 507 and bottom surface 501a of the measuring portion main body can be, for example, 90°<θ<180°, preferably 90°<θ≦135°.

In the present embodiment, the shape of the measuring portion main body (the shape as viewed in the lamination direction of the substrate) is not particularly limited; however, as shown in FIG. 5, the shape is preferably a triangular shape or an approximately triangular shape. In measuring portion 500 shown in FIG. 5, such a shape is realized by the straight-line-shaped wall surface from discharging outlet 504 to introducing inlet 503 that first wall 510 has and the V-letter-shaped wall surface that second wall 520 has. When the measuring portion main body is constructed with use of a V-letter-shaped wall surface, air hardly stays within the measuring portion main body when the liquid is introduced into the measuring portion main body, and the measuring portion main body can be filled with the liquid with certainty, so that an accurate measurement can be made. Here, the wall surface of second wall 502 is not limited to a V-letter shape, and can be, for example, a U-letter shape. Also, the wall surface from discharging outlet 504 to introducing inlet 503 of first wall 510 need not have a straight line shape, and can have, for example, a V-letter shape or a U-letter shape in a manner similar to second wall 520.

In the case where the shape of the measuring portion main body is a triangular shape or an approximately triangular shape, the introducing inlet is preferably disposed at one corner of the triangular shape and the discharging outlet is preferably disposed at another corner of the triangular shape as in measuring portion 500 of FIG. 5. By this, the whole space within the measuring portion main body will be filled with the liquid.

In the present embodiment, the shape of the connecting flow path is not particularly limited. However, from the viewpoint of the facility in molding the flow path, the connecting flow path preferably has a straight line shape (the connecting flow path has, for example, a quadrilateral shape such as a square shape, a rectangular shape, or a trapezoid shape as viewed in the lamination direction of the substrates). Also, the length of the connecting flow path (the distance from the discharging outlet of the measuring portion main body to the opening) is preferably 1.0 mm or larger, in view of the fact that the liquid surface (liquid separation interface) formed in the connecting flow path and measuring portion main body 501 are preferably spaced apart from each other as much as possible in order to restrain to the minimum the quantity of the liquid to be measured that is drawn by the exhaust liquid and discharged, and is preferably 2.0 mm or smaller from the viewpoint of reducing the occupied space.

Next, opening 502 will be described in detail. In measuring portion 500 shown in FIGS. 5 and 6, opening 502 is made of a through-hole that penetrates through first substrate 601 in the thickness direction. By application of a centrifugal force, the extraneous liquid (exhaust liquid) exceeding the capacity among the liquid introduced into measuring portion main body 501 flows out to opening 502 connected to the connecting flow path 505 end portion, and the exhaust liquid is stored into the second fluid circuit formed by first substrate 601 and third substrate 603. By such an operation, the inside of measuring portion main body 501, a part of the inside of connecting flow path 505, and a part of the inside of introducing flow path 506 are filled with the liquid, whereby the liquid is measured. In this manner, the liquid that should stay within connecting flow path 505 and measuring portion main body 501 as the measured liquid is separated from the exhaust liquid that should flow out to opening 502 at the connecting flow path 505 side opening of opening 502, so that the liquid separation between these liquids is good. That is, the liquid that should stay within connecting flow path 505 and measuring portion main body 501 is effectively prevented from being drawn by the exhaust liquid to flow out, and the measurement errors can be made smaller.

Here, among the inner wall surfaces of opening 502, a side wall surface 502a continuous to bottom surface 505a of the connecting flow path is preferably tilted relative to the thickness direction of first substrate 601 so that the inner angle α formed by side wall surface 502a and bottom surface 505a of the connecting flow path will be less than 90°. By providing such a tilt, the above-described separation is made more effectively, and the liquid separation can be more improved. In this case, the inner angle α can be, for example, about 80°≦α<90°. Also, not only side wall surface 502a may be tilted but also the through-hole itself that constitutes opening 502 may have a tapered shape such that the cross sectional area of the opening will increase accordingly as it goes from the connecting flow path 505 side to the second fluid circuit side. By forming a tapered shape, the liquid can be prevented from touching the side wall surface and the liquid is prevented from being drawn by surface tension or the like more effectively. Also, in order that the above-described separation is carried out effectively, the region at which side wall surface 502a and bottom surface 505a of the connecting flow path cross each other preferably has a corner part formed as shown in FIG. 6 rather than being made of a curved surface.

The opening shape (shape as viewed in the lamination direction of the substrates) of opening 502 shown in FIG. 5 is a quadrilateral shape; however, the shape is not limited to this, so that it can assume various shapes such as a circular shape, a polygonal shape, and the like. However, the opening shape of the opening is preferably determined in consideration of the relationship between the connecting surface of the connecting flow path to the opening (the surface at which the connecting flow path and the opening are connected) and the liquid surface of the liquid after the measurement as shown below.

FIGS. 7A to 7C are enlarged views showing the neighborhood of the connecting flow path and the opening of the measuring portion, and are schematic top surface views showing the relationship between the connecting surface of the connecting flow path to the opening and the liquid surface of the liquid after the measurement. The dotted line in FIGS. 7A to 7C show the position of the liquid surface of the measured liquid when the application of a centrifugal force is stopped after the measurement. FIG. 7A shows a case of a measuring portion having the same structure as measuring portion 500 shown in FIG. 5. As shown in FIG. 7A, by adjusting the direction of the connecting surface of the connecting flow path and the opening so that the connecting surface will have an angle instead of being parallel to the liquid surface of the measured liquid, the contact of the liquid surface to the opening will be a point contact, so that the liquid separation of the measured liquid that should stay within the connecting flow path and the measuring portion main body from the exhaust liquid will be improved, and the measurement errors can be reduced.

On the other hand, when the opening shape of the opening is made to have a circular shape (FIG. 7B) or the connecting surface of the connecting flow path and the opening is made parallel to the liquid surface of the measured liquid (FIG. 7C), the contact of the liquid surface to the opening will not be a point contact (or hardly becomes a point contact), and the liquid separation tends to be not so good as in the case of FIG. 7A. Therefore, the connecting flow path and the opening are preferably connected with each other and the opening shape of the opening is preferably adjusted so that the connecting surface of the connecting flow path to the opening will have an angle to the liquid surface of the measured liquid. Here, the direction of a centrifugal force at the time of introducing the liquid into the measuring portion main body and performing the measurement is preferably a direction such as a direction of forming a liquid surface position shown in FIGS. 7A to 7C, namely such that the whole space of the measuring portion main body, a part of the inside of the connecting flow path, and a part of the inside of the introducing flow path will be filled with the liquid.

Here, in FIG. 6, opening 502 is made of a through-hole that penetrates through first substrate 601 in the thickness direction; however, in the present embodiment, the opening is not limited to such a mode. For example, the opening may be a groove (recessed part) provided on the first substrate surface. In this case, the exhaust liquid will be stored into the inside of the groove.

Next, introducing flow path 506 that is connected to introducing inlet 503 will be described. Introducing flow path 506 has a function of guiding the liquid to introducing inlet 503 and also has a function of controlling the flow rate of the liquid that is introduced to the measuring portion main body. By restricting the flow rate of the liquid to a suitable amount, air is restrained or prevented from being mixed with the liquid into the measuring portion main body. Here, when the depth N of introducing flow path 506 is made smaller than the depth L of the measuring portion main body, the flow rate controlling function of introducing flow path 506 can be further improved. In order to impart a good flow rate controlling function, the depth N and the width of introducing flow path 506 respectively are preferably about 0.2 to 0.5 mm. Also, due to the reasons similar to the above, bottom surface 501a of the measuring portion main body and the bottom surface of introducing flow path 506 are connected with each other by a tilted surface.

In the present embodiment, an air hole 530 is preferably provided in the measuring portion as shown in FIG. 5. By forming the air hole, a passageway is ensured for discharging the air that is present within the measuring portion main body or the air that flows in together at the time of introducing the liquid, whereby the movement of the liquid such as the introduction of the liquid into the measuring portion main body and the discharging of the exhaust liquid can be smoothly carried out. The position of the air hole is not particularly limited. The air hole can be formed, for example, by forming a recessed part in the wall formed on the first substrate surface.

Hereafter, the microchip of the present invention will be described by showing examples; however, the present invention is not limited to this.

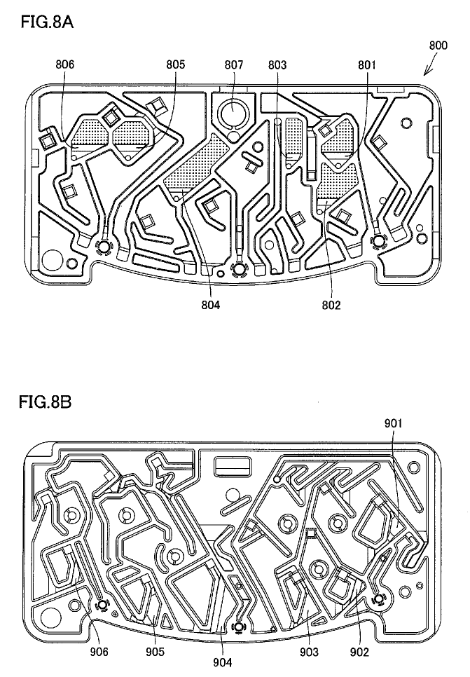

FIGS. 8A, 8B, 9A, 9B, 10A, and 10B are plan views showing one example of the microchip of the above-described second embodiment, and showing a state of the liquid within the fluid circuit before the use of the microchip and a state of the liquid in a part of the fluid processing steps that are performed with use of the microchip. FIGS. 8A, 9A, and 10A show a groove shape formed on one surface of the first substrate, and show the structure of one fluid circuit (hereafter also referred to as an upper side fluid circuit) among the two fluid circuits of two layers that the microchip has. FIGS. 8B, 9B, and 10B show a groove shape formed on the other surface of the first substrate, and show the structure of the other fluid circuit (hereafter also referred to as a lower side fluid circuit) that the microchip has. Actually, this microchip 800 has a second substrate and a third substrate that interpose and hold the first substrate; however these are not shown in FIGS. 8A, 8B, 9A, 9B, 10A, and 10B. Hereafter, with reference to FIGS. 8A, 8B, 9A, 9B, 10A, and 10B, the microchip will be described with respect to a part of the fluid processing operations.

FIGS. 8A and 8B are plan views showing a state before performing the fluid processing (before use). As shown in FIGS. 8A and 8B, microchip 800 includes liquid reagent holding portions 801, 802, 803, 804, 805, and 806 for storing the liquid reagents that are mixed with a plasma component or a blood cell component within whole blood, and incorporates liquid regents R1, R2, R3, R4, R5, and R6 respectively within these liquid reagent holding portions in advance. The specimen serving as an object of testing/analysis (whole blood) is introduced into the fluid circuit from a specimen injecting inlet 807. Also, microchip 800 has liquid reagent measuring portions 901, 902, 903, 904, 905, and 906 which are the measuring portions according to the second embodiment of the present invention. These measuring portions are portions for measuring the liquid regents R1, R2, R3, R4, R5, and R6, respectively.

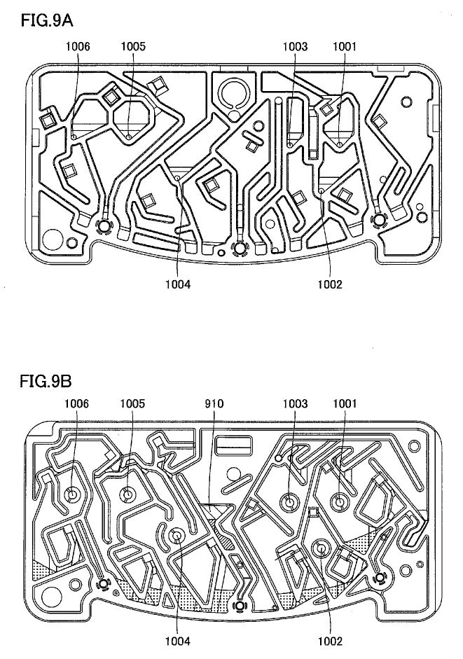

In the whole blood testing using microchip 800, first the collected whole blood is introduced from specimen injecting inlet 807. Next, with reference to FIGS. 9A and 9B, a centrifugal force in the downward direction (downward direction in FIGS. 9A and 9B) is applied. By this, the whole blood is introduced into a separating portion 910, and is separated into a plasma component and a blood cell component by centrifugation (see FIG. 9B). Also, by this downward centrifugal force, the liquid reagents pass through through-holes 1001, 1002, 1003, 1004, 1005, and 1006 that penetrate through the first substrate in the thickness direction, respectively, so as to move to the lower side fluid circuit (see FIG. 9B).

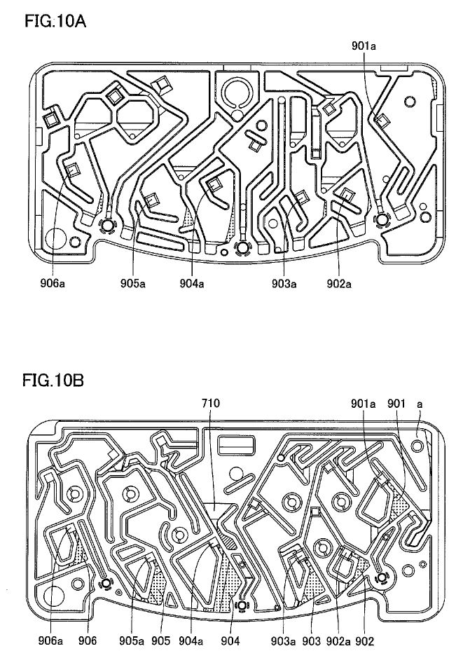

Subsequently, with reference to FIGS. 10A and 10B, a centrifugal force in a rightward direction (rightward direction in FIGS. 10A and 10B) is applied. By this, the plasma component within separating portion 910 moves to a region a (see FIG. 10B). Also, the liquid reagents R1, R2, R3, R4, R5, and R6 that have moved to the lower side fluid circuit which is a fluid circuit on the side having measuring portions are introduced into liquid reagent measuring portions 901, 902, 903, 904, 905, and 906, respectively, and are measured (see FIG. 10B). The details of the measuring operation are as described above. These liquid reagent measuring portions are provided with openings 901a, 902a, 903a, 904a, 905a, and 906a, respectively, that are disposed to oppose to the measuring portion main body so as to interpose the connecting flow path therebetween, and the extraneous reagents (exhaust liquid) that has overflowed out from the connecting flow path pass through the openings, respectively, and move to the upper side fluid circuit to be stored (see FIG. 10A). In this manner, according to microchip 800 of the present example, the liquid reagents R1 to R6 can be measured accurately and simultaneously with use of the liquid reagent measuring portions. Also, in each of the liquid reagent measuring portions, reduction of the occupied area in the fluid circuit is achieved. Here, by application of a centrifugal force in a suitable direction after obtaining the state shown in FIGS. 10A and 10B, fluid processing such as measurement of the plasma component and the blood cell component, mixing of the plasma component or the blood cell component with each reagent, and the like is carried out; however, the explanation will not shown here.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A microchip having a fluid circuit therein and formed by bonding a first substrate having a groove provided on a surface of the substrate and a second substrate together, wherein
said fluid circuit includes at least a measuring portion for measuring liquid and a flow path connected to one end of said measuring portion, and a length of a cross section of said measuring portion at a connecting position of said flow path and said measuring portion in a thickness direction of the microchip is shorter than a length of a cross section of said flow path at the connecting position of said flow path and said measuring portion in the thickness direction of the microchip.

2. The microchip according to claim 1, wherein a bottom surface or a ceiling surface of said measuring portion and a bottom surface or a ceiling surface of said flow path are formed at an identical position relative to the thickness direction of the microchip.

3. The microchip according to claim 1, wherein a bottom surface and a ceiling surface of said measuring portion are formed at different positions respectively from a bottom surface and a ceiling surface of said flow path relative to the thickness direction of the microchip.

4. The microchip according to claim 1, wherein said fluid circuit has one or more specimen measuring portions for measuring a specimen and one or more liquid reagent measuring portions for measuring a liquid reagent, and said measuring portion is any one or more measuring portions selected from said specimen measuring portions and said liquid reagent measuring portions.

5. The microchip according to claim 1, wherein said first substrate is a transparent substrate, and said second substrate is a black substrate.

6. A microchip including a first substrate having a groove on a surface and/or a through-hole that penetrates in a thickness direction and a second substrate laminated on said first substrate, and having a first fluid circuit made of a hollow portion composed of said groove and a surface of said second substrate on a side of said first substrate,
wherein
said first fluid circuit has a measuring portion for measuring liquid,
said measuring portion includes:
a measuring portion main body that is a chamber for measuring said liquid and includes an introducing inlet disposed at one end thereof for introducing said liquid and a discharging outlet disposed at the other end thereof for discharging said liquid,
an opening that is made of the groove provided on the surface of said first substrate or the through-hole penetrating in the thickness direction; and
a connecting flow path that connects said discharging outlet and said opening, and
said measuring portion main body and said opening are disposed to oppose each other with said connecting flow path interposed therebetween.

7. The microchip according to claim 6, wherein a depth L of said measuring portion main body is larger than a depth M of said connecting flow path.

8. The microchip according to claim 7, wherein a ratio L/M of the depth L of said measuring portion main body to the depth M of said connecting flow path is within a range of from 2/1 to 9/1.

9. The microchip according to claim 7, wherein a bottom surface of said measuring portion main body and a bottom surface of said connecting flow path are connected by a tilted surface.

10. The microchip according to claim 6, wherein a side wall surface continuous to the bottom surface of said connecting flow path among the side wall surfaces of the groove or the through-hole constituting said opening is tilted relative to the thickness direction of said first substrate so that an inner angle formed by the side wall surface and the bottom surface of said connecting flow path becomes smaller than 90 degrees.

11. The microchip according to claim 6, wherein said connecting flow path and said opening are connected so that a connecting surface thereof will have an angle relative to a liquid surface of said liquid subjected to measurement within said connecting flow path.

12. The microchip according to claim 6, wherein an introducing flow path for introducing said liquid to said introducing inlet is connected to said introducing inlet, and
a depth N of said introducing flow path is smaller than a depth L of said measuring portion main body.

13. The microchip according to claim 12, wherein a bottom surface of said measuring portion main body and a bottom surface of said introducing flow path are connected by a tilted surface.

14. The microchip according to claim 6, wherein said measuring portion main body has a approximately triangular shape, and is provided with said introducing inlet at one corner and said discharging outlet at another corner in said approximately triangular shape.

15. The microchip according to claim 6, which is a microchip including a first substrate having a groove formed on both surfaces and/or a through-hole penetrating in a thickness direction and a second substrate and a third substrate that interpose and hold said first substrate therebetween, and having a first fluid circuit made of a hollow portion composed of said groove disposed on one surface of said first substrate and a surface of said second substrate on a side of said first substrate and a second fluid circuit made of a hollow portion composed of said groove disposed on the other surface of said first substrate and a surface of said third substrate on a side of said first substrate, wherein said opening is made of a through-hole that penetrates through said first substrate in a thickness direction and connects said first fluid circuit and said second fluid circuit.
